(19) United States
(12) Patent Application Publication
(10) Pub. No.: US 2026/0290789 A1
(43) Pub. Date: Sep. 24, 2026

(54) MANUFACTURING METHOD FOR NEGATIVE ELECTRODE, AND MANUFACTURING METHOD FOR ELECTRICAL ENERGY STORAGE DEVICE

(71) Applicant: Prime Planet Energy & Solutions, Inc., Tokyo (JP)

(72) Inventors: Shohei UNOKI, Kobe-shi (JP); Naoki UCHIDA, Kakogawa-shi (JP); Toshi NAKAGAWA, Kobe-shi (JP); Yasuhiro UEYAMA, Nishinomiya-shi (JP)

(21) Appl. No.: 19/568,794

(22) Filed: Mar. 17, 2026

(30) Foreign Application Priority Data
Mar. 19, 2025 (JP) 2025-044164

(51) Int. Cl. H01M 4/1393; H01M 4/02; H01M 4/04; H01M 4/133; H01M 4/134; H01M 4/1395; H01M 4/38; H01M 4/583; H01M 4/62; H01M 10/058

(52) U.S. Cl. CPC H01M 4/1393; H01M 4/0404; H01M 4/133; H01M 4/134; H01M 4/1395; H01M 4/386; H01M 4/583; H01M 4/625; H01M 10/058; H01M 2004/021; H01M 2004/027

(57) ABSTRACT

A manufacturing method for a negative electrode disclosed herein includes a preparing step of preparing a negative electrode slurry by kneading graphite and a Si-containing material as a negative electrode active material, a binder, and a fibrous carbon material in a dispersion medium including at least water, and a coating step of coating a negative electrode current collector with the negative electrode slurry, thereby forming a negative electrode mixture layer. The negative electrode slurry is prepared in the preparing step so that the degree of blackness becomes 30 or more and 65 or less and the viscosity at a shear rate of 100 s⁻¹ becomes 1100 mPa·s or less.

### CROSS REFERENCE TO RELATED APPLICATION

This application claims the benefit of priority to Japanese Patent Application No. 2025-044164 filed on Mar. 19, 2025. The entire contents of this application are hereby incorporated herein by reference.

### BACKGROUND OF THE DISCLOSURE

### 1. Field

The present disclosure relates to a manufacturing method for a negative electrode, and a manufacturing method for an electrical energy storage device.

### 2. Background

A negative electrode of an electrical energy storage device generally has a structure in which a negative electrode mixture layer including a negative electrode active material is supported by a negative electrode current collector. Such a negative electrode can be manufactured in such a way that, for example, materials of the negative electrode mixture layer such as the negative electrode active material are kneaded in water to prepare a slurry, and the prepared slurry is applied to the negative electrode current collector (for example, see Japanese Patent Application Publication No. 2023-096785 and Japanese Patent Application Publication No. 2020-113485).

### SUMMARY

In recent years, using a Si-containing material as the negative electrode active material has been examined from the viewpoints of increasing the capacity, and the like. According to the present inventors' examination, however, the Si-containing material is highly reactive with water. Therefore, if the Si-containing material is cracked due to a kneading load at the preparation of the slurry, gas (typically, hydrogen gas) tends to be generated on a new surface. This results in a problem that air bubbles are mixed in the slurry to cause a coating failure easily.

The present disclosure has been made in view of the above circumstances, and a main object thereof is to provide a manufacturing method for a negative electrode that can improve the coating failure due to mixing of air bubbles.

A manufacturing method for a negative electrode according to one aspect of the present disclosure includes a preparing step of preparing a negative electrode slurry by kneading graphite and a Si-containing material as a negative electrode active material, a binder, and a fibrous carbon material in a dispersion medium including at least water, and a coating step of coating a negative electrode current collector with the negative electrode slurry, thereby forming a negative electrode mixture layer. Here, when, in a light absorption spectrum measured with an optical path length of 25 mm, regarding a sample obtained in such a way that the negative electrode slurry is mixed with ion exchanged water 10 mass times the negative electrode slurry, centrifugal separation is performed, a supernatant liquid is collected, and the supernatant liquid is diluted by 5 volume times with the ion exchanged water, a value obtained by multiplying a total of light absorbances at wavelengths of 600 nm, 700 nm, 800 nm, and 900 nm by 5 is defined as a degree of blackness, the negative electrode slurry is prepared in the preparing step so that the degree of blackness becomes 30 or more and 65 or less and a viscosity at a shear speed of 100 s⁻¹ becomes 1100 mPa·s or less.

According to the present inventors' examination, the aforementioned “degree of blackness” serves as the index of the load applied to the negative electrode slurry at the kneading, and a correlation with the amount of gas (air bubble) generation is recognized. In addition, the aforementioned “viscosity” serves as the index of the coatability of the negative electrode slurry. When the degree of blackness and the viscosity of the negative electrode slurry are in the aforementioned ranges, the negative electrode slurry allowing less air bubble mixing can be applied stably and the coating failure due to air bubble mixing can be improved.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a flowchart of a manufacturing method according to one embodiment;

FIG. 2 is a graph showing a relation between the viscosity and the degree of blackness of a negative electrode slurry; and

FIG. 3 is a graph showing a relation between the degree of blackness of the negative electrode slurry and the amount of gas generation.

### DETAILED DESCRIPTION OF THE PREFERRED EMBODIMENTS

Hereinafter, preferred embodiments of the art disclosed herein will be described. Matters that are other than matters particularly mentioned in the present specification and that are necessary for the implementation of the art disclosed herein (for example, the general configuration and manufacturing process of an electrical energy storage device that do not characterize the art disclosed herein) can be grasped as design matters of those skilled in the art based on the prior art in the relevant field. The art disclosed herein can be implemented on the basis of the disclosure of the present specification and common technical knowledge in the relevant field.

Note that in the present specification, the term “electrical energy storage device” refers to general devices that are capable of being charged and discharged repeatedly, and corresponds to a concept that encompasses a secondary battery such as a lithium ion secondary battery or a nickel-hydrogen secondary battery, and moreover, a capacitor such as an electric double-layer capacitor, a lithium ion capacitor, or a pseudo-capacitor. In addition, in the present specification, the notation “A to B” for a range signifies a value more than or equal to A and less than or equal to B, and is meant to encompass also the meaning of being “preferably more than A” and “preferably less than B”

### [Manufacturing Method for Negative Electrode]

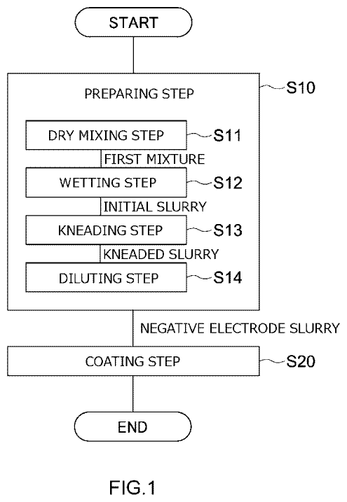

FIG. 1 is a flowchart of a manufacturing method according to one embodiment. As illustrated in FIG. 1, the manufacturing method for a negative electrode disclosed herein includes a preparing step (step S10) of preparing a negative electrode slurry and a coating step (step S20) of coating a negative electrode current collector with the negative electrode slurry, thereby forming a negative electrode mixture layer in this order. The manufacturing method disclosed herein may further include another step at an optional stage. For example, the coating step (step S20) may be followed by, for example, a pressing step of rolling the negative electrode mixture layer on the negative electrode current collector. The manufacturing method for the negative electrode disclosed herein is preferably a manufacturing method for a negative electrode for a secondary battery and more preferably a manufacturing method for a negative electrode for a lithium ion secondary battery.

The preparing step (step S10) is a step of preparing a predetermined negative electrode slurry (including a paste and an ink) by kneading (1) a negative electrode active material, (2) a binder, and (3) a fibrous carbon material in a dispersion medium including at least water. First, each of the aforementioned materials (1) to (3) used here is described.
(1) The negative electrode active material is a material that can reversibly store and release charge carriers. In this embodiment, the negative electrode active material necessarily includes (1a) graphite and (1b) a Si-containing material. Thus, the characteristics of an electrical energy storage device (for example, high capacity and high-rate cycle characteristic) can be achieved at a high level.
(1a) The graphite may be one kind, or two or more kinds of graphite that has been known as being usable as the negative electrode active material, without particular limitations. The graphite may be either natural graphite or artificial graphite, and may be amorphous carbon covering graphite in which a graphite particle, which is a core, is covered with an amorphous carbon material.

The graphite is typically in a particle form (powder form). Although there is no particular limitation, the average particle diameter of the graphite (a particle diameter (D50) at a cumulative value of 50% in a particle size distribution based on the volume measured in accordance with a laser diffraction/scattering method) is preferably 1 to 100 μm, more preferably 5 to 50 μm, and still more preferably 10 to 30 μm. The graphite typically has a spherical shape, a plate shape, a flake shape, or the like. The average aspect ratio (major axis/minor axis ratio based on an electron microscope) of the graphite is typically smaller than that of (3) the fibrous carbon material to be described below, and can be for example 5 or less and preferably 3 or less. That is to say, the graphite typically has higher sphericity than the fibrous carbon material.
(1b) The Si-containing material may be one kind, or two or more kinds of Si-containing materials that include Si and have been known as being usable as the negative electrode active material, without particular limitations. Examples thereof include Si (silicon), a SiC composite material, silicon oxide represented by SiOₐ (in which 0.05<a<1.95), silicon carbide represented by SiC_{b} (in which 0<b<1), silicon nitride represented by SiN_{c} (in which 0<c<4/3), and the like. The SiC composite material typically has a structure in which a Si particle is disposed in a pore of a porous skeleton made of carbon. The present inventors' examination indicates that a crack tends to occur in the SiC composite material particularly due to a load at the kneading (kneading load). Therefore, in the case of using the SiC composite material, it is particularly preferable to apply the art disclosed herein.

The Si-containing material is typically in the particle form (powder form). Although there is no particular limitation, the average particle diameter of the Si-containing material (the particle diameter (D50) at a cumulative value of 50% in the particle size distribution based on the volume measured in accordance with the laser diffraction/scattering method) is preferably 1 to 20 μm, more preferably 1 to 10 μm, and still more preferably 5 to 10 μm. The Si-containing material typically has a spherical or substantially spherical shape, or the like. The average aspect ratio (major axis/minor axis ratio based on the electron microscope) of the Si-containing material can be typically smaller than that of (3) the fibrous carbon material to be described below, and is for example 3 or less and preferably 2 or less and can be 1.5 or less. That is to say, the Si-containing material typically has higher sphericity than the fibrous carbon material.
(2) The binder is a component that increases the integrity of the negative electrode mixture layer by binding (1) the negative electrode active material and (3) the fibrous carbon to be described below. The binder is not limited in particular and one kind or two or more kinds of materials that have been known as being usable for this type of application conventionally can be used without particular limitations. Examples thereof include rubbers such as styrene butadiene rubber (SBR), celluloses such as carboxymethyl cellulose (CMC), and acrylic resins (resin obtained by polymerizing monomers with an acryloyl group) such as polyacrylic acid (PAA). It is preferable to include a plurality of kinds of such binders and more preferable to contain SBR, CMC, and PAA altogether.
(3) The fibrous carbon is a component that increases the conductivity in the negative electrode mixture layer. Note that, in this specification, “the fibrous carbon” refers to a carbon material in a fibrous form (string form) whose average aspect ratio (average fiber length/average outer diameter) is 10 or more. The fibrous carbons have an average aspect ratio of preferably 20 or more, more preferably 50 or more, and still more preferably 100 or more. When the average aspect ratio is the predetermined value or more, it is easy to obtain the negative electrode mixture layer in which the fibrous carbon links between negative electrode active material particles and even in the case of using (1b) the Si-containing material, it is easy to form a favorable conductive path in the negative electrode mixture layer. The average aspect ratio of the fibrous carbons is preferably about 100,000 or less and more preferably 50,000 or less, and may be 10,000 or less. When the average aspect ratio is the predetermined value or less, more fibrous carbons cover surfaces of the negative electrode active material particles together with the binder, making it easy to form a favorable conductive path on the surfaces of the negative electrode active material particles. That is to say, when the fibrous carbons have the average aspect ratio in the aforementioned range, it is possible to form the conductive path between the active material particles and for each of the surfaces of the electrode active material particles and further enhance the conductivity in the negative electrode mixture layer. In addition, when the average aspect ratio is in the aforementioned range, the negative electrode slurry easily satisfies the properties to be described below (in particular, the range of the degree of blackness) stably and the effect of the art disclosed herein is achieved easily.

The average fiber length of the fibrous carbons is typically 1.5 μm or more, and may be 1.6 μm or more, 1.7 μm or more, 1.8 μm or more, 1.9 μm or more, or 2.0 μm or more. When the average fiber length is the predetermined value or more, it is easy to form the favorable conductive path in the negative electrode mixture layer. The average fiber length of the fibrous carbons may be 1.5 to 5.0 μm, 1.8 to 3.0 μm, or 2.0 to 2.5 μm. When the average fiber length is in the aforementioned range, the negative electrode slurry easily satisfies the properties to be described below (in particular, the range of the degree of blackness) stably and the effect of the art disclosed herein is achieved easily.

Note that the average fiber length and the average outer diameter (average diameter) of the fibrous carbons can be obtained by observing the plurality of fibrous carbons with the electron microscope, measuring the length of each fibrous carbon in a major axis direction and in a radial direction in the obtained image, and calculating the number average value. More specifically, for example, first, the plurality of fibrous carbons are observed at an acceleration voltage of 1 kV using a scanning electron microscope (SEM); thus, a SEM image is obtained. Next, the average outer diameter can be obtained in such a way that the lengths in the radial direction of the plurality of fibrous carbons arbitrarily extracted from the SEM image are measured and the number average value thereof is calculated. Moreover, the average fiber length can be obtained in such a way that the fibrous carbons in the SEM image are individually painted linearly with image software, the circumferential length of the line is measured, a half value of the circumferential length is used as the fiber length, and the number average value thereof is calculated. Note that since the fibrous carbon has the average fiber length that is extremely longer than the average outer diameter, the width of the line that affects the circumferential length can be ignored.

A G/D ratio of the fibrous carbon on the basis of laser Raman spectroscopy may be 100 or less, 95 or less, and 90 or less, is preferably 85 or less, and may be 80 or less. As the value of the G/D ratio is smaller, the crystallinity is lower and more structure defects are generated. As a result, it can be said that the strength is low and disconnection occurs easily due to the kneading load. Thus, it is particularly preferable to apply the art disclosed herein. The G/D ratio of the fibrous carbon may be 5 to 100, 10 to 90, or 10 to 80. When the G/D ratio is the predetermined value or more, it is easy to form the favorable conductive path in the negative electrode mixture layer. In addition, when the G/D ratio is in the aforementioned range, the negative electrode slurry easily satisfies the properties to be described below (in particular, the range of the degree of blackness) stably and the effect of the art disclosed herein is achieved easily.

Note that the G/D ratio of the fibrous carbon is obtained as a ratio of a maximum peak intensity G of a G band appearing around 1590 cm⁻¹ to a maximum peak intensity D of a D band appearing around 1350 cm⁻¹ in a Raman spectrum obtained by the laser Raman spectroscopy. The G band is the peak derived from the graphite structure and the D band is the peak derived from the defect of the structure. More specifically, for example, first, a dispersion liquid is prepared by dispersing the fibrous carbons in a dispersion medium (such as water), and taking the prepared dispersion liquid on a cover glass. Next, the range with a diameter of 300 μm is irradiated with laser light with an excitation wavelength of 532 nm to obtain the Raman spectrum with a Raman microscope. Then, in the obtained Raman spectrum, the maximum peak intensity in the range of 1550 to 1650 cm⁻¹ is defined as G and the maximum peak intensity in the range of 1300 to 1400 cm⁻¹ is defined as D; thus, the G/D ratio can be calculated.

The kind of fibrous carbon is not limited in particular and one kind or two or more kinds of materials that have been known as being usable for this type of application conventionally can be used without particular limitations. Examples thereof include carbon nanotube (CNT), carbon fiber, carbon nanofiber, and the like. In particular, CNT is preferably contained because the conductivity is excellent, for example.

CNT is a fibrous carbon with a structure in which graphite constituting a carbon hexagonal network is rounded into a tubular shape. CNT may be single-walled carbon nanotube (SWCNT) with a structure in which graphite in one layer is rounded into a tubular shape, double-walled carbon nanotube (DWCNT) with a structure in which graphite in two layers is rounded into a tubular shape, or multi-walled carbon nanotube (MWCNT) with a structure in which graphite in three or more layers is rounded into a tubular shape. In particular, SWCNT is preferable because the structure defects are fewer and the aforementioned range for the G/D ratio is achieved easily. CNT may include impurities (for example, catalyst or amorphous carbon) derived from a manufacturing process, for example.

In this embodiment, in this step, the aforementioned (1) to (3) materials are kneaded in the dispersion medium to prepare the negative electrode slurry so that the following two conditions are satisfied: (A) “the degree of blackness” to be described below is 30 or more and 65 or less; and (B) “the viscosity” at a shear rate of 100 s⁻¹ is 1100 mPa·s or less. Note that (A) the degree of blackness in this specification is the value to be measured as follows. That is to say, first, the negative electrode slurry is mixed with an ion exchanged water 10 mass times the negative electrode slurry and the mixture is subjected to centrifugal separation; then, a supernatant liquid is extracted. This supernatant liquid is diluted by 5 volume times with the ion exchanged water to obtain a sample for measurement. Next, a light absorption spectrum of the obtained sample is measured at an optical path length of 25 mm. Then, in the obtained light absorption spectrum, the total of the light absorbances at the wavelengths of 600 nm, 700 nm, 800 nm, and 900 nm is multiplied by 5; thus, the value of (A) the degree of blackness can be obtained. More specific measurement methods for (A) the degree of blackness and (B) the viscosity will be described in Example below.

According to the present inventors' examination, (A) the degree of blackness of the negative electrode slurry serves as the index of the load applied to the negative electrode slurry at the kneading. That is to say, as the value of (A) the degree of blackness is larger, the light absorbance is higher (in other words, the light transmittance is lower) and more free components exist. As described above, since (3) the fibrous carbon material is in the fibrous form, the aspect ratio thereof is relatively larger than that of (1) the negative electrode active material and the fibrous carbon material is easily disconnected due to the load at the kneading. (3) The fibrous carbon material that is disconnected and freed will not be easily deposited by centrifugal separation at the measurement of (A) the degree of blackness. Therefore, it is considered that the value of (A) the degree of blackness is largely dependent on the amount of (3) the fibrous carbon material that is disconnected and freed. In addition, the value of the degree of blackness may reflect the load applied to the negative electrode slurry at the kneading.

As will be described below in Test Examples, the present inventors have found out that (A) the degree of blackness of the negative electrode slurry is in a negative correlation with the amount of gas (air bubble) generation. Therefore, from the viewpoint of preparing the negative electrode slurry allowing less air bubble mixing by suppressing the gas generation, it is considered preferable to adjust the kneading load so that (A) the degree of blackness becomes the predetermined value or more in this step. The reason why setting (A) the degree of blackness to be the predetermined value or more suppresses the air bubble mixing is considered as follows, although the limited interpretation is not intended in particular. That is to say, (1b) the Si-containing material is a material that is cracked easily due to the kneading load. Moreover, since (1b) the Si-containing material is highly reactive with water as described above, the crack of the Si-containing material due to the kneading load makes it easy to generate gas (typically, hydrogen gas) on a new surface. However, when the Si-containing material is cracked due to the kneading load, if the freed fibrous carbons exist in large quantity around the exposed new surface, the new surface tends to be covered with the free fibrous carbons immediately. Therefore, while the Si-containing material is suitably broken, combining with the freed fibrous carbon progresses more easily. It is considered that the exposure of the new surface can be prevented because a surface of the Si-containing material is coated with such freed fibrous carbons and these are combined. As a result, it is considered that the generation of gas (air bubbles) can be suppressed.

In addition, (B) the viscosity of the negative electrode slurry serves as the index of the coatability (coating easiness, shape stability, or the like) in the coating step (step S20) and its correlation with (A) the degree of blackness or the kneading load is recognized. Therefore, from the viewpoint of coating the negative electrode slurry stably, (B) the viscosity is preferably less than or equal to the predetermined value. When the degree of blackness and the viscosity of the negative electrode slurry are in the aforementioned ranges, the negative electrode slurry in which the mixing of air bubbles is suppressed and the coatability is excellent can be stably prepared.

In this embodiment, this step includes at least a kneading step. In accordance with the load applied to the negative electrode slurry in the kneading step, specifically a kneading method and a kneading condition, (A) the degree of blackness and (B) the viscosity of the negative electrode slurry can be adjusted. As illustrated in FIG. 1, here, this step includes a dry mixing step (step S11), a wetting step (step S12), the kneading step (step S13), and a diluting step (step S14) in this order. In another embodiment, however, the step other than the kneading step, for example, the drying mixing step or the wetting step can be omitted as appropriate. Alternatively, this step may include another step at an optional stage.

In each step, one kind, or two or more kinds of the conventionally known mixing or kneading method can be employed as appropriate as long as (A) the degree of blackness and (B) the viscosity of the negative electrode slurry satisfy the aforementioned ranges. The mixing or kneading can be performed using, for example, a multi-screw kneader such as a twin-screw kneader, a single-screw kneader, a planetary mixer, a disperser, a ball mill, a jet mill, a mortar, a spatula, or the like. Note that in one example to be described below in detail regarding each step, three kinds of SBR, CMC, and PAA are used as (2) the binder.

The dry mixing step (step S11) is a step of preliminary mixing materials in the powder form, thereby obtaining a first mixture in the powder form. Specifically, (1a) the graphite and (1b) the Si-containing material as (1) the negative electrode active material that are prepared as above and CMC and PAA in the powder form as (2) the binder are weighed so as to satisfy a predetermined mass ratio and mixed by a dry mixing method (dry mix). Thus, the homogeneity and integrity of the negative electrode mixture layer can be improved.

Although there is no particular limitation, the mixing ratio between (1a) the graphite and (1b) the Si-containing material is preferably graphite:Si-containing material=95:5 to 40:60 and more preferably 90:10 to 60:40. It is preferable that (1) the negative electrode active material contain the graphite as a primary component (whose mass ratio is the largest, and this definition applies similarly to the description below) and it is more preferable that the negative electrode active material contain the graphite as a main component (whose mass ratio is 50 mass % or more, and this definition applies similarly to the description below). When the total amount of (1) the negative electrode active material is 100 mass %, the content ratio of (1a) the graphite is preferably 50 to 95 mass % and more preferably 60 to 90 mass %. When the total amount of (1) the negative electrode active material is 100 mass %, the content ratio of (1b) the Si-containing material is preferably 5 to 50 mass % and more preferably 10 to 30 mass %.

Although there is no particular limitation, the total of (1a) the graphite and (1b) the Si-containing material constitutes preferably 80 mass % or more, more preferably 90 mass % or more, and still more preferably 95 mass % or more of the entire (1) negative electrode active material, and the negative electrode active material may substantially be formed of (1a) the graphite and (1b) the Si-containing material (the total of both components may constitute 98 mass % or more). However, the negative electrode active material may further include another negative electrode active material that is known to be usable as the negative electrode active material, typically in a content ratio that is smaller than the content ratios of (1a) the graphite and (1b) the Si-containing material. The content ratio of the other negative electrode active material is preferably 10 mass % or less and more preferably 5 mass % or less of the entire negative electrode active material.

Although there is no particular limitation, when (1) the negative electrode active material is 100 parts by mass, the ratio of each of CMC and PAA as (2) the binder is preferably 0.1 to 5 parts by mass, more preferably 0.5 to 4 parts by mass, and still more preferably 1 to 3 parts by mass.

Note that the dry mixing step does not use the dispersion medium (for example, water) or (3) the fibrous carbon. Therefore, according to the present inventors' examination, the influence of this step on the properties of the negative electrode slurry, particularly (A) the degree of blackness or (B) the viscosity is remarkably smaller than that in the subsequent steps (step S12 to S14). Therefore, the dry mixing step and the mixing condition in this step may be similar to the conventional ones, without particular limitations. In one example, the mixing may be performed lightly using the planetary mixer typically with the number of rotations (15 rpm, for example) lower than that in the subsequent steps (step S12 to S14). The mixing time may be generally about one hour or less, preferably 30 minutes or less (for example, about 10 minutes).

The wetting step (step S12) is a step of adding and mixing (3) the fibrous carbon and the dispersion medium containing water in the first mixture in the powder form obtained by the dry mixing step (step S11), thereby obtaining an initial slurry. In some embodiments, it is preferable that (3) the fibrous carbon be diffused in advance in the dispersion medium (for example, water) and added as the dispersion liquid. In addition, the dispersion medium is typically water but may alternatively be a mixed solvent containing one kind or two or more kinds of organic solvents to be mixed with water. As the organic solvent to be mixed with water, an organic solvent that is mixed with water uniformly, for example alcohol, ether, ketone, low carboxylic acid, or the like can be used. The dispersion medium preferably contains water mainly (by 50 mass % or more), more preferably contains water by 80 mass % or more, still more preferably contains water by 95 mass % or more, and particularly preferably consists of water substantially (98 mass % or more is water). The dispersion medium (for example, water) is preferably added so that a solid content ratio (non-volatile value (NV value)) of the initial slurry, in other words, the solid content ratio when the kneading is performed in the kneading step (step S13) is about 50 mass % or more, preferably 55 mass % or more, for example 55 to 65 mass %, and more preferably 62 mass % or less. When the solid content ratio of the initial slurry is set in the aforementioned range, the suitable kneading load (shear force) can be applied to the slurry in the kneading step (step S13) to be described below, and the negative electrode slurry can easily be prepared stably so as to have the desired properties (in particular, the degree of blackness). In addition, the homogeneous negative electrode slurry is easily obtained.

Although there is no particular limitation, when (1) the negative electrode active material is 100 parts by mass at the kneading in the kneading step (step S13), the ratio of (3) the fibrous carbon material is preferably 0.01 to 1 part by mass, more preferably 0.01 to 0.1 parts by mass, and still more preferably 0.05 to 0.1 parts by mass. In some embodiments, the ratio of (3) the fibrous carbon material is preferably smaller than the ratio of (2) the binder added in the previous dry mixing step (step S11), that is, CMC and/or PAA. When the ratio of (3) the fibrous carbon material is in the aforementioned range, the negative electrode slurry can easily be prepared stably so as to have the desired properties (in particular, the degree of blackness).

Note that the influence of this step on the properties of the negative electrode slurry, particularly (A) the degree of blackness and (B) the viscosity is relatively smaller than that of the kneading step (step S13) to be described below. Therefore, it is preferable not to apply the excess load to the slurry, although the mixing method and the mixing condition of this step are not limited in particular. In one example, after the fibrous carbons and the dispersion medium (for example, water) are added so that the NV value becomes within the aforementioned range (for example, 58 to 62 mass %), the mixture may be mixed manually for about 1 to 5 minutes (for example, 3 minutes) using the spatula. Alternatively, after the fibrous carbons and the dispersion medium (for example, water) are added so that the NV value becomes within the aforementioned range (for example, 62 mass % or less), the mixture may be mixed for about 1 to 5 minutes (for example, 3 minutes) using the planetary mixer with the number of rotations set to about 50 rpm or less (for example, 30 rpm). At this time, the number of rotations of the planetary mixer is preferably set to be less than or equal to that in the subsequent steps (steps S13 and S14).

The kneading step (step S13) is a step of kneading (kneading in a solid state) the initial slurry obtained in the wetting step (step S12), thereby obtaining a kneaded slurry. According to the present inventors' examination, a strong shear force is applied to the slurry in this step; therefore, the material in the powder form (particularly, (1b) the Si-containing material) is easily cracked or (3) the fibrous carbons are easily disconnected due to the kneading load. Therefore, this step has a particularly large influence on the properties of the negative electrode slurry, especially (A) the degree of blackness or (B) the viscosity. Accordingly, adjusting the mixing method or the mixing condition in this step makes it possible to apply the suitable load to the slurry and easily prepare the negative electrode slurry with the desired properties (in particular, the degree of blackness) efficiently.

According to the present inventors' examination, the negative electrode slurry is easily prepared so as to have (A) the degree of blackness and (B) the viscosity within the aforementioned ranges in accordance with any of the following methods in this step: (method 1) the kneading is performed using the multi-screw kneader for a relatively short time; and (method 2) the kneading is performed using the planetary mixer for a relatively long time. In particular, (method 1) is more preferable because the effect of the art disclosed herein is achieved easily at a high level. Moreover, since (method 1) can shorten the kneading time, the productivity and the workability can also be improved.

(Method 1) performs the kneading for a relatively short time using the multi-screw kneader. The kneading time is about 300 seconds or less, preferably 180 seconds or less, more preferably 90 seconds or less, and particularly preferably 70 seconds or less from the viewpoints of reducing the excess damage of the powder material (particularly, (1b) the Si-containing material), and the like. The kneading time is preferably 10 seconds or more, more preferably 20 seconds or more, and still more preferably 25 seconds or more from the viewpoints of applying the suitable load to the material in the powder form (particularly, (3) the fibrous carbon) and kneading the slurry homogeneously, and the like. The multi-screw kneader typically includes a barrel (kneading chamber), a shaft provided in the barrel, and a driving mechanism that drives the shaft. In particular, a twin-screw kneader having two shafts disposed in substantially parallel in the barrel is preferable. The two shafts are preferably equipped with a rotary paddle. As the kneading condition, a gap (paddle clearance) between an edge part of the rotary paddle and an inner wall of the barrel is preferably about 0.5 to 5 mm (for example, 1 mm).

In (method 2), the kneading is performed for a relatively long time using the planetary mixer. The kneading time is about 1000 seconds or more, preferably 1200 seconds (20 minutes) or more, and more preferably 1800 seconds (30 minutes) or more from the viewpoints of applying the suitable load to the material in the powder form (particularly (3) the fibrous carbon) and kneading the slurry homogeneously. The kneading time is preferably 10000 seconds or less, more preferably 5400 seconds (90 minutes) or less, and for example preferably 5000 to 6000 seconds from the viewpoints of reducing the excess damage of the powder material (particularly (1b) the Si-containing material), improving the productivity, and the like. As the kneading condition, the number of rotations of the planetary mixer is preferably about 100 rpm or less and more preferably 50 rpm or less (for example, 30 to 50 rpm).

The diluting step (step S14) is a step of adding the dispersion medium as described above (for example, water) further to the kneaded slurry obtained in the kneading step (step S13), thereby obtaining the negative electrode slurry with the predetermined solid content ratio (NV value). Thus, the coatability in the coating step (step S20) to be described below can be improved. This step is also a step of further adding (2) the binder (SBR) in a liquid form here. The dispersion medium and/or the binder (SBR) may be added all at once or in multiple stages. In addition, the order of adding the dispersion medium and the binder (SBR) is not limited in particular; however, in one example, it is preferable to add the binder (SBR) after the dispersion medium is added to the kneaded slurry so as to obtain the predetermined solid content ratio to some extent in order to avoid the excess load on the slurry.

The solid content ratio (NV value) of the negative electrode slurry is not limited in particular; however, in some embodiments, the solid content ratio is preferably about 30 to 50 mass %, more preferably 35 to 45 mass %, and still more preferably 40 to 45 mass %.

Note that the solid content ratio of the slurry is low in the diluting step; therefore, the influence on (A) the degree of blackness and (B) the viscosity of the negative electrode slurry is relatively smaller than that in the previous kneading step (step S13). Accordingly, in some embodiments, in the case of performing the dilution at one time, it is preferable to add the dispersion medium to the kneaded slurry so as to obtain the predetermined solid content ratio (NV value), stir the mixture with a planetary centrifugal mixer, add the binder (SBR), and then stir the mixture manually, although the mixing method and the mixing condition are not limited in particular. As the stirring condition of the planetary centrifugal mixer, for example, the number of rotations may be about 500 to 3000 rpm (for example, 2000 rpm) and the time may be about 1 to 5 minutes (for example, 3 minutes). The stirring time performed manually may be about 1 to 5 minutes (for example, 3 minutes).

Alternatively, in some embodiments, in the case of performing the dilution in multiple stages, every time the dispersion medium is added to the kneaded slurry, the mixture may be mixed using the planetary mixer at a rotation number of about 50 rpm or less (for example, 45 rpm) for about 1 to 5 minutes (for example, 5 minutes). Then, at last, the binder (SBR) may be added and the mixture may be mixed at a rotation number of about 50 rpm or less (for example, 30 rpm) for about 1 to 5 minutes (for example, 5 minutes). Thus, the negative electrode slurry can be prepared.

When (1) the negative electrode active material is 100 parts by mass in the negative electrode slurry, the ratio of (2) the binder (here, the total ratio of CMC, PAA, and SBR) is preferably 0.1 to 10 parts by mass, more preferably 0.5 to 8 parts by mass, and still more preferably 1 to 5 parts by mass. In some embodiments, the ratio of (2) the binder is preferably larger than the ratio of (3) the fibrous carbon material. When the ratio of (2) the binder is in the aforementioned range, the negative electrode slurry with the desired properties (particularly, (B) the viscosity) is easily prepared stably.

In the negative electrode slurry, (A) the degree of blackness may be 30 to 65, and is preferably 35 or more, more preferably 40 or more, still more preferably 45 or more, and particularly preferably 50 or more. Thus, the generation of gas can be suppressed at the high level and the mixing of air bubbles can be reduced more. In some embodiments, (A) the degree of blackness may be 60 or less.

In the negative electrode slurry, (B) the viscosity may be 1100 mPa·s or less, and is preferably 1000 mPa·s or less, more preferably 700 mPa·s or less, and still more preferably 600 mPa·s or less. Thus, the discharge failure can be suppressed at the high level and the coatability can be improved more. In some embodiments, (B) the viscosity is preferably 100 mPa·s or more, more preferably 200 mPa·s or more, still more preferably 300 mPa·s or more, and particularly preferably 400 mPa·s or more. Thus, the liquid dripping of the negative electrode slurry can be suppressed and the coatability can be improved more.

The coating step (step S20) is a step of coating the negative electrode current collector with the negative electrode slurry obtained in the preparing step (step S10), thereby forming the negative electrode mixture layer. The negative electrode current collector is preferably formed of a metal and is more preferably formed of, for example, a conductive metal such as copper, a copper alloy, nickel, or stainless steel. The negative electrode current collector is preferably a metal foil, and for example, more preferably a copper foil or a copper alloy foil. Although there is no particular limitation, the thickness of the metal foil is 5 to 35 μm and preferably 6 to 20 μm, for example.

A surface (one surface or both surfaces) of the negative electrode current collector can be coated with the negative electrode slurry using a coating device such as a gravure coater, a slit coater, a die coater, a comma coater, or a dip coater. The amount of coating may be determined as appropriate in accordance with the solid content ratio of the negative electrode slurry or the like, for example, so that the negative electrode mixture layer has the desired properties (thickness or the like). Since the negative electrode slurry includes the dispersion medium (for example, water) in this embodiment, the dispersion medium is preferably removed by drying the negative electrode mixture after coating. The negative electrode mixture can be dried in accordance with a procedure similar to a conventional one, for example heat drying, reduced-pressure drying, or the like. Thus, the negative electrode mixture layer including (1a) the graphite, (1b) the Si-containing material, (2) the binder, and (3) the fibrous carbon can be formed on the surface of the negative electrode current collector.

### [Manufacturing Method for Electrical Energy Storage Device]

The electrical energy storage device can be manufactured by, for example, a manufacturing method including a manufacturing step of manufacturing an electrode assembly using the negative electrode manufactured by the above manufacturing method, and a constructing step of constructing the electrical energy storage device using the manufactured electrode assembly.

In the electrode assembly manufacturing step, the electrode assembly is manufactured using the negative electrode described above. Specifically, first, a positive electrode and a separator are prepared separately. These may be similar to the conventional ones, without particular limitations. Then, the negative electrode manufactured by the aforementioned manufacturing method is disposed facing the positive electrode through the separator. In one example, the positive electrode with a band shape and the negative electrode with a band shape are stacked through the separator with a band shape and wound using a winding axis as a center. Thus, the electrode assembly is manufactured. In the constructing step, the electrode assembly is accommodated in a battery case; thus, the electrical energy storage device is constructed. Specifically, first, an electrolyte is prepared separately. The electrolyte may be similar to the conventional one, without particular limitations. The electrolyte is preferably a nonaqueous electrolyte solution including a nonaqueous solvent (organic solvent) and a supporting salt (electrolyte salt). Next, the electrode assembly manufactured in the electrode assembly manufacturing step and the prepared electrolyte are accommodated in the battery case. Thus, the electrical energy storage device can be manufactured.

### [Application of Electrical Energy Storage Device]

The electrical energy storage device can be used in various applications, and suitably used in the application that requires high capacity and a high input-output characteristic, for example, a motive power source (electrical power source for driving) for a motor mounted on a vehicle such as a passenger car or a truck. Although the type of vehicles is not particularly limited, examples thereof may include a plug-in hybrid electric vehicle (PHEV), a hybrid electric vehicle (HEV), a battery electric vehicle (BEV), and the like.

Several test examples relating to the present disclosure will be explained below, but the present disclosure is not meant to be limited to these test examples.

### [Preparation of Negative Electrode Slurry]

First, the negative electrode slurries (Examples 1 to 8, Comparative Examples 1 to 3) were prepared by preparing the materials shown in Table 1 below and changing the conditions in the preparing step in FIG. 1.

TABLE 1

| Material | Kind | Details | Ratio | |
|---|---|---|---|---|
| (1) Negative | (1a) Graphite | Artificial | 90 | mass % |
| electrode active | | graphite | | |
| material | (1b) Si- | SiC | 10 | mass % |
| | containing | composite | | |
| | material | material | | |
| (2) Binder | Celluloses | CMC | 1 | mass %* |
| | Acrylic resin | PAA | 1 | mass %* |
| | Rubbers | SBR | 0.05 | mass %* |
| (3) Fibrous carbon | CNT | SWCNT | 1 | mass %* |

*The externally added ratio when the entire amount of the negative electrode active material (1a + 1b) is 100 mass %

In Examples 1 to 7, first, the negative electrode active materials shown in Table 1 (graphite and the Si-containing material (SiC composite material)), and carboxymethyl cellulose (CMC) and polyacrylic acid (PAA) as the binder were weighed to satisfy the aforementioned mass ratio, and the mixture was mixed in a dry procedure for 10 minutes under a condition of 15 rpm using the planetary mixer; thus, the first mixture in the powder form was obtained (dry mixing step). Next, SWCNT (in a state of a CNT dispersion liquid, G/D ratio=69) as the fibrous carbon and the dispersion medium (water) were added to the obtained first mixture, the NV value was adjusted to obtain the NV value shown in Table 2 (58 to 62 mass %), and the mixture was kneaded manually using the spatula for 3 minutes; thus, the initial slurry was obtained (wetting step). Subsequently, the initial slurry was kneaded for the time shown in Table 2 (22.4 to 67.2 seconds) using the twin-screw kneader with a paddle clearance of 1 mm and the number of rotations set to 900 rpm; thus, the kneaded slurry was obtained (kneading step). Next, the dispersion medium (water) was added to the kneaded slurry for one-shot dilution using the planetary centrifugal mixer (the number of rotations: 2000 rpm, 3 minutes). Next, styrene butadiene rubber (SBR) as the binder was added so that the NV value was adjusted to be 42 mass % finally; then, the mixture was kneaded for 5 minutes manually using the spatula (diluting step). Thus, the negative electrode slurry was prepared.

In Example 8 and Comparative Examples 1 to 3, first, the first mixture in the powder form was obtained in a manner similar to the above process (dry mixing step). Next, SWCNT (in a state of the CNT dispersion liquid) as the fibrous carbon and the dispersion medium (water) were added to the obtained first mixture, the NV value was adjusted to obtain the NV value shown in Table 2 (62 or 64 mass %), and the mixture was kneaded for 3 minutes using the planetary mixer with the number of rotations set to 30 rpm; thus, the initial slurry was obtained (wetting step). Subsequently, the initial slurry was kneaded for the time shown in Table 2 (30 minutes or 90 minutes) using the planetary mixer with the number of rotations set to 50 rpm; thus, the kneaded slurry was obtained (kneading step). Next, the dilution was performed in multiple stages, that is, five separate times, by adding the dispersion medium (water) to the kneaded slurry and using the planetary mixer. Specifically, the dilution followed by mixing for 5 minutes with the number of rotations set to 45 rpm was repeated 5 times. Next, styrene butadiene rubber (SBR) as the binder was added so that the NV value was adjusted to be 42 mass % finally; then, the mixture was kneaded for 5 minutes using the planetary mixer with the number of rotations set to 30 rpm (diluting step). Thus, the negative electrode slurry was prepared.

### [Measurement of Viscosity of Negative Electrode Slurry]

The viscosity of the negative electrode slurry prepared as above was measured using a rheometer manufactured by Anton Paar (model: MCR102, parallel plate: PP50). Specifically, the shear rate dependency (flow curve) at 0.01 to 3170 per second (1/s) was measured under the 25° C. environment, and the viscosity value at 100 per second (1/s) was employed. The results are shown in Table 2.

### [Measurement of Degree of Blackness of Negative Electrode Slurry]

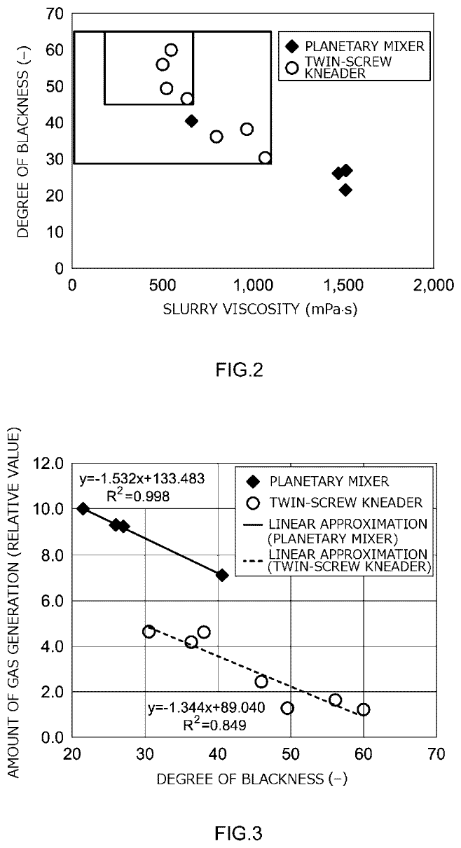

The negative electrode slurry prepared as above was mixed with the ion exchanged water 10 mass times the negative electrode slurry. The obtained mixture was subjected to centrifugal separation for 30 minutes with a centrifugal force of 10000 G or more using a centrifugal separator. Next, the separated supernatant liquid was collected and this supernatant liquid was diluted by 5 volume times with the ion exchanged water. A part of the obtained mixture was collected as a measurement sample. Subsequently, the light absorption spectrum of this sample was measured with an optical path length of 25 mm using a known spectrometer. Then, the light absorbances at wavelengths of 600 nm, 700 nm, 800 nm, and 900 nm in the obtained light absorption spectrum were obtained. Then, these light absorbance values were totaled and multiplied by 5; thus, the degree of blackness was obtained. The results are shown in Table 2. FIG. 2 also shows the relation between the viscosity and the degree of blackness of the negative electrode slurry.

### [Measurement of Amount of Gas Generation in Negative Electrode Slurry]

The negative electrode slurry prepared as above was collected by 2 g and sealed in an aluminum pouch, which was then stored in a thermostatic bath set to 60° C. for three days. The pouch volume before and after storage was determined by an electronic hydrometer based on Archimedes' principle. The amount of gas generated (typically hydrogen gas) was calculated from the change in pouch volume before and after storage. The results are shown in Table 2. Note that Table 2 shows the relative values when the amount of gas generation in Comparative Example 3 is 100. FIG. 3 also shows the relation between the degree of blackness of the negative electrode slurry and the amount of gas generation.

### [Evaluation of Coatability of Negative Electrode Slurry]

Whether the negative electrode slurry prepared as above was able to be continuously discharged stably for 3 minutes or more from a discharge port of a coating device of a slit die type (model name: New table-top die coater Mini-100) was checked. The results are shown in Table 2. Note that Table 2 shows “Good” when the stable discharging is possible and “Not Good” when the discharge failure occurs.

TABLE 2

| | | | | Evaluation of negative electrode slurry | | | |
|---|---|---|---|---|---|---|---|
| | Kneading step | | | | Degree | Amount | |
| | | Solid | | | of | of gas | |
| | | content | Kneading | | blackness | generation | |
| | Kneading | ratio | time | Viscosity | (5 times | (relative | |
| | device | (wt %) | (s) | (mPa · s) | value) | value) | Coatability |
| Example 1 | Twin-screw | 58 | 22.4 | 1,066 | 30.6 | 45 | Good |
| | kneader | | | | | | |
| Example 2 | Twin-screw | 58 | 44.8 | 798 | 36.3 | 42 | Good |
| | kneader | | | | | | |
| Example 3 | Twin-screw | 60 | 22.4 | 966 | 38.3 | 46 | Good |
| | kneader | | | | | | |
| Example 4 | Twin-screw | 60 | 44.8 | 652 | 45.9 | 23 | Good |
| | kneader | | | | | | |
| Example 5 | Twin-screw | 60 | 67.2 | 521 | 49.5 | 12 | Good |
| | kneader | | | | | | |
| Example 6 | Twin-screw | 62 | 44.8 | 501 | 56.1 | 16 | Good |
| | kneader | | | | | | |
| Example 7 | Twin-screw | 62 | 67.2 | 546 | 60.1 | 12 | Good |
| | kneader | | | | | | |
| Example 8 | Planetary | 62 | 5,400 | 659 | 40.6 | 71 | Good |
| | mixer | | | | | | |
| Comparative | Planetary | 62 | 1,800 | 1,473 | 26.1 | 93 | Not Good |
| Example 1 | mixer | | | | | | |
| Comparative | Planetary | 64 | 1,800 | 1,514 | 27.1 | 93 | Not Good |
| Example 2 | mixer | | | | | | |
| Comparative | Planetary | 64 | 5,400 | 1,511 | 21.6 | 100 | Not Good |
| Example 3 | mixer | | | | | (reference) | |

As shown in FIG. 2, the negative correlation was recognized between the viscosity and the degree of blackness of the negative electrode slurry. Therefore, from the viewpoint of the coatability, it is effective to set the viscosity of the negative electrode slurry to 1100 mPa's or less and set the degree of blackness of the negative electrode slurry to 65 or less. In addition, as shown in Table 2, no slurry discharge failure from the coating device occurred and the coatability was superior in Examples 1 to 8, as compared to Comparative Examples 1 to 3.

As shown in FIG. 3, the negative correlation was observed between the degree of blackness of the negative electrode slurry and the amount of gas generation. That is to say, as the degree of blackness was higher, the amount of gas generation was likely to decrease. Therefore, from the viewpoint of suppressing gas generation, it is effective to set the degree of blackness of the negative electrode slurry to 30 or more. Moreover, as shown in Table 2 and FIG. 3, the amount of gas generation was a half or less, which was remarkably low, in Examples 1 to 8 in which the degree of blackness was 30 or more, as compared to Comparative Examples 1 to 3.

It is considered that this is because of the influence from the crack of the Si-containing material and the disconnection of the fibrous carbons due to the kneading load, although the limited interpretation is not intended in particular. That is to say, when the Si-containing material is cracked due to the kneading load, if many free fibrous carbons exist around the exposed new surface, the new surface is easily covered with the free fibrous carbons. It is considered that covering the surface of the Si-containing material with the free fibrous carbons in this manner makes it possible to prevent the exposure of the new surface and suppress the generation of gas (air bubbles).

Moreover, Examples 1 to 7 using the twin-screw kneader in the kneading step and Example 8 and Comparative Examples 1 to 3 using the planetary mixer in the kneading step are different from each other in inclination of an approximate curve as shown in FIG. 3. Therefore, it is understood that the suitable condition (kneading load) in the kneading step can vary depending on the kneading device to be used. Even if the degree of blackness is the same, the amount of gas (air bubble) generation was suppressed in (method 1) where the kneading is performed for a relatively short time using the multi-screw kneader compared to (method 2) where the kneading is performed for a relatively long time using the planetary mixer. The reason is considered as follows: it is important that when the Si-containing material is cracked and the new surface is exposed, many free fibrous carbons exist and the new surface is immediately covered with the fibrous carbons.

Although the preferable embodiments of the present disclosure have been described above, they are merely examples. The present disclosure can be implemented in various other modes. The present disclosure can be implemented based on the contents disclosed in the present specification and the technical common sense in the relevant field. The techniques described in the scope of claims include those in which the embodiments exemplified above are variously modified and changed.

As described above, the following items are given as specific aspects of the art disclosed herein.
Item 1: The manufacturing method for the negative electrode, including: the preparing step of preparing the negative electrode slurry by kneading the graphite and the Si-containing material as the negative electrode active material, the binder, and the fibrous carbon material in the dispersion medium including at least water; and the coating step of coating the negative electrode current collector with the negative electrode slurry, thereby forming the negative electrode mixture layer, in which when, in the light absorption spectrum measured with an optical path length of 25 mm, regarding the sample obtained in such a way that the negative electrode slurry is mixed with the ion exchanged water 10 mass times the negative electrode slurry, the centrifugal separation is performed, the supernatant liquid is collected, and the supernatant liquid is diluted by 5 volume times with the ion exchanged water, the value obtained by multiplying the total of light absorbances at the wavelengths of 600 nm, 700 nm, 800 nm, and 900 nm by 5 is defined as the degree of blackness, the negative electrode slurry is prepared in the preparing step so that the degree of blackness becomes 30 or more and 65 or less and the viscosity at a shear rate of 100 s⁻¹ becomes 1100 mPa·s or less.
Item 2: The manufacturing method for the negative electrode according to Item 1, in which the G/D ratio of the fibrous carbon material in accordance with the laser Raman spectroscopy is 100 or less.
Item 3: The manufacturing method for the negative electrode according to Item 1 or 2, in which the fibrous carbon material is the single-walled carbon nanotube.
Item 4: The manufacturing method for the negative electrode according to any one of Items 1 to 3, in which the solid content ratio of the slurry at the kneading is 55 mass % or more and 65 mass % or less.
Item 5: The manufacturing method for the negative electrode according to any one of Items 1 to 4, in which when the negative electrode active material is 100 parts by mass at the kneading, the ratio of the fibrous carbon material is 0.01 parts by mass or more and 0.1 parts by mass or less.
Item 6: The manufacturing method for the negative electrode according to any one of Items 1 to 5, in which when the negative electrode active material is 100 parts by mass, the ratio of the binder is 1 part by mass or more and 5 parts by mass or less in the negative electrode slurry.
Item 7: The manufacturing method for the negative electrode according to any one of Items 1 to 6, in which the negative electrode slurry is prepared so as to have a viscosity of 300 mPa·s or more and 600 mPa·s or less.
Item 8: The manufacturing method for the negative electrode according to any one of Items 1 to 7, in which the kneading is performed using the multi-screw kneader for a kneading time of 90 seconds or less in the preparing step.
Item 9: The manufacturing method for the electrical energy storage device, in which the electrode assembly is manufactured using the negative electrode obtained by the manufacturing method for the negative electrode according to any one of Items 1 to 8, and the electrical energy storage device is constructed using the electrode assembly.

What is claimed is:

1. A manufacturing method for a negative electrode, comprising:
a preparing step of preparing a negative electrode slurry by kneading graphite and a Si-containing material as a negative electrode active material, a binder, and a fibrous carbon material in a dispersion medium including at least water; and
a coating step of coating a negative electrode current collector with the negative electrode slurry, thereby forming a negative electrode mixture layer, wherein
when, in a light absorption spectrum measured with an optical path length of 25 mm, regarding a sample obtained in such a way that the negative electrode slurry is mixed with ion exchanged water 10 mass times the negative electrode slurry, centrifugal separation is performed, a supernatant liquid is collected, and the supernatant liquid is diluted by 5 volume times with the ion exchanged water, a value obtained by multiplying a total of light absorbances at wavelengths of 600 nm, 700 nm, 800 nm, and 900 nm by 5 is defined as a degree of blackness, the negative electrode slurry is prepared in the preparing step so that the degree of blackness becomes 30 or more and 65 or less and a viscosity at a shear rate of 100 s⁻¹ becomes 1100 mPa·s or less.

2. The manufacturing method for a negative electrode according to claim 1, wherein a G/D ratio of the fibrous carbon material in accordance with laser Raman spectroscopy is 100 or less.

3. The manufacturing method for a negative electrode according to claim 2, wherein the fibrous carbon material is single-walled carbon nanotube.

4. The manufacturing method for a negative electrode according to claim 1, wherein a solid content ratio of the slurry at the kneading is 55 mass % or more and 65 mass % or less.

5. The manufacturing method for a negative electrode according to claim 1, wherein when the negative electrode active material is 100 parts by mass at the kneading, a ratio of the fibrous carbon material is 0.01 parts by mass or more and 0.1 parts by mass or less.

6. The manufacturing method for a negative electrode according to claim 1, wherein when the negative electrode active material is 100 parts by mass, a ratio of the binder is 1 part by mass or more and 5 parts by mass or less in the negative electrode slurry.

7. The manufacturing method for a negative electrode according to claim 1, wherein the negative electrode slurry is prepared so as to have a viscosity of 300 mPa·s or more and 600 mPa·s or less.

8. The manufacturing method for a negative electrode according to claim 1, wherein the kneading is performed using a multi-screw kneader for a kneading time of 90 seconds or less in the preparing step.

9. A manufacturing method for an electrical energy storage device, wherein an electrode assembly is manufactured using a negative electrode obtained by the manufacturing method for a negative electrode according to claim 1, and an electrical energy storage device is constructed using the electrode assembly.
